(19) United States
(12) Patent Application Publication
(10) Pub. No.: US 2003/0176521 A1
(43) Pub. Date: Sep. 18, 2003

(54) Initiator and ultraviolet absorber for changing lens power by ultraviolet light

(75) Inventors: Jagdish M. Jethmalani, San Diego, CA (US); Shiao H. Chang, Pasadena, CA (US)

Correspondence Address: FULBRIGHT & JAWORSKI, LLP, 1301 MCKINNEY, SUITE 5100, HOUSTON, TX, 77010-3095, US

(73) Assignee: CALHOUN VISION, Pasadena, CA

(21) Appl. No.: 10/319,082

(22) Filed: Dec. 13, 2002

Related U.S. Application Data
(60) Provisional application No. 60/344,249, filed on Dec. 28, 2001.

(51) Int. Cl. C08G 2/00

(52) U.S. Cl. 522/46

(57) ABSTRACT

Novel blends of photo-initiators and photo-absorbers are disclosed. By the proper selection of the type and amount of absorber used in a composition, it is possible to regulate the conditions under which photo-induced reactions occur. In a specific embodiment, blends of UV initiators and UV absorbers are used to control the conditions under which UV initiated polymerization occurs.

The present application claims the benefit of the priority data in U.S. Application No. 60/344,249, filed Dec. 28, 2001.

### BRIEF SUMMARY OF THE INVENTION

The invention relates to a method for controlling the conditions under which photopolymerizable occurs. The invention also relates to a novel blend of light absorbing compounds and photoinitiators which permits the selection of the conditions under which the photoinitiator induces photopolymerization.

### BACKGROUND OF THE INVENTION

Photopolymerization is widely used to produce fabricated articles used to cure photopolymerizable compositions. One recent application of photopolymerization is the development of optical elements whose optical properties can be changed through the use of photopolymerizable modifying composition dispersed within the optical element.

There exists a need, however, to control the conditions under which photopolymerization occurs. For example, in one embodiment of the optical element described above, intraocular lenses are first implanted into a patient and then adjusted post-operatively to meet the retractive needs of the patient. This post-operative correction preferably occurs after wound healing is complete. This allows the surgeon to take into account any changes in the lens or its position that might occur due to the wound healing process.

The healing process may take up to several weeks, during which time it is necessary to avoid photopolymerization of the modifying composition. This requires that the patient shield his eyes from potential light sources that could cause photopolymerization. This severely restricts the patient's abilities to resume a normal routine after surgery.

Thus, it is desirable to control the conditions under which photopolymerization occurs such that the photopolymerization occurs at a predetermined set of conditions.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### SUMMARY OF THE INVENTION

The invention relates to a method of controlling the conditions under which stimulus-induced polymerization occurs. Specifically, it involves the use of blends of stimulus-absorbing compounds and stimulus-initiator compounds wherein the proportion of the two types of compounds are such that the initiation of polymerization is delayed until a desired set of conditions are reached.

In the preferred embodiment, a light-absorbing compound is used in conjunction with a photoinitiator to limit the action of the photoinitiator to a point that the absorbance of the light-absorbing compound has been reached. In a particularly preferred embodiment, the absorber compound is a UV absorber and the initiator is a UV initiator.

### DETAILED DESCRIPTION OF THE INVENTION

The invention relates to a method of controlling the conditions under which photopolymerization occurs by blending a photoabsorber and a photoinitiator together and then combining them with the monomers or macromers to the polymerized. By balancing the nature and relative proportions of the absorber and initiator, it is possible to control the conditions under which photopolymerization occurs.

A novel blend of photoabsorbers and photoinitiators is also provided. When the photoabsorber and photoinitiator are combined in correct proportions, a novel composition from controlling photoinitiated photopolymerization is created. Using these novel blends it is possible to control the threshold intensity and wavelength of light required to induce polymerization. Similarly, the duration of exposure needed to induce polymerization can also be determined.

The photoabsorber composition used in the blend should absorb light in the same part of the spectrum that induces the photoinitiator to initiate polymerization. For example, if the photoinitiator is sensitive to ultraviolet light, the photoabsorbing component should be capable of absorbing ultraviolet light. If the photoinitiator is sensitive to infrared, then the photoabsorber must absorb infrared radiation. Photoinhibitors may also be used either in lieu or in addition to the photoabsorber. For example, in the case of UV light, photoinhibitors such as hinderamines, hydrogurmones as methoxy phenols may be used. The light absorber used in the practice of the invention may also comprise a blend of one or more absorbers. For example, in the case of UV absorber, the UV absorber comprised may comprise a blend of UV absorbtion which absorbs light and efficient frequencies.

Typical UV absorbers include benzotriazoles, benzophenones and the like. In the preferred embodiment, the photoabsorber is an ultraviolet absorber. One particularly useful class of UV absorbers are the benzotriazoles having the general structure:

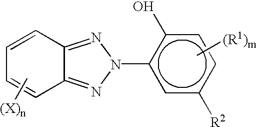

wherein X is independently selected from the group consisting of H, monovalent hydrocarbon radicals and monovalent substituted hydrocarbon radicals preferably containing 1 to about 8 carbon atoms, hydroxyl radicals, amino radicals, carboxyl radicals alkoxy radicals and substituted alkoxy radicals, preferably containing 1 to 6 carbon atoms and halogen radicals; each R¹ is independently selected from the group consisting of H, alkyl radicals, substituted alkyl radicals, alkoxy radicals, substituted alkoxy radicals, preferably containing 1 to 8 carbon atoms, more preferably containing 1 to 4 carbon atoms, comprising either, or more hydroxyl radicals, amino radicals and carboxyl radicals, n is an integer of from 1 to 4 and m is an integer of from 1-3. Preferably, at least one of the X, R¹ is other than H. R₂ is selected from a moiety comprising hydride, vinyl, acrylate, methacrylate or silicone.

Examples of useful monovalent hydrocarbon radicals include alkyl radicals, alkenyl radicals, oryl radicals and the like. Examples of useful alkoxy radicals include methoxy, ethoxy, propyoxy, butoxy, hexoxy and the like. Useful alkyls include methyl, ethyl, propyl, butyl, hexyl, octyl and the like. A particularly useful halogen is chlorine.

The substituted groups referred to herein are exemplified by the above noted groups (and the other groups referred to herein) substituted with one or more substituted groups including elements such as oxygen, nitrogen, carbon, hydrogen, halogen, sulfur, phosphorous and the like and mixtures or combinations thereof. Examples of useful amine groups include —NH₂ and groups in which one or both Hs is replaced with a group selected from monovalent hydrocarbon radicals, monovalent substituted hydrocarbon radicals and the like.

It is preferred that no more than one of the Xs is other than H and that no more than one of the R¹ is other than H. That is, it is preferred that all or all but one of the Xs be H and all or all but one of the R¹ be H. Such “minimally” substituted benzotriazole moieties are relatively easy to produce and provide outstanding ultraviolet-absorbing properties.

In lieu of ultraviolet absorbers, ultraviolet inhibitors may also be used. UV inhibitors which may be used in the practice of the invention include hindered amines, hydroquinones, methoxy phenones and the like. The compounds may be substituted for the UV absorbers described above.

A particularly useful class of UV-absorbing compounds is selected from compounds having the following formula or structure:

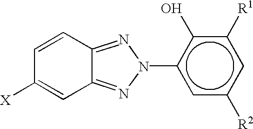

wherein X=chloro and R¹=tertiary butyl and R² having a vinyl group most preferred.

The preferred UV-absorbing compounds absorb UV light strongly in the range of 300 nm to 400 nm, and exhibit reduced absorption at wavelengths higher than about 400 nm.

The amount of UV absorber is that required to give the degree of light absorption desired and is dependent, for example, on the specific UV absorber used, the photoinitiator used, the composition of the element in which UV absorber is to be used, the macromers to be polymerized and the thickness, e.g., optical paths, of the element. By Beers Law of absorption, A=εbc, when A=absorbence, ε=extension coefficient, d=thickness and c=concentration of the absorber. The required amount of absorber is inversely proportional to the optical path length. It is often desired that the UV light transmission at 400 nm be less than 10 to 15% of the incidental light, and at 390 nm be less than 3%.

As with the photoabsorber, the preferred photoinitiator useful in the practice of the invention are UV-sensitive photoinitiators. Particularly preferred photoinitiators are x-alky/benzoins having the general formula or structure:

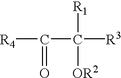

wherein R³ is H, alkyl radical, aryl radical, substituted alkyl, or substituted aryl radical, and R⁴ is H, alkyl radical, aryl radical, substituted alkyl or substituted aryl radical; R⁵ and R⁶ are phenyl or substituted phenyl. Specific examples of R³ and R⁴ groups include methyl, phenyl trifluoropropyl, ethyl and cyano propyl. Phenyl substituents from the R⁵ and R⁶ groups may include alkyl, alkoxy, halogen, alkaryl, cyano alkyl, haloalkyl and N,N dialkyl amino. Photoinitiator useful in the practice of the invention include Irgacure 819, Irgacure 184, Irgacure 369 and Irgacure 651 all available from Ciba Specialty Chemicals Inc.. Where clarity is required, such as in optical elements, Irgacure 651 is preferred.

Also useful in the practice of the invention are photoinititators having two initiators linker by a short polymer backbone. One such compound is Benzoin polydimethyl siloxane Benzoin (B-pdms-B) wherein two benzoin moieties are linked by a dimethyl siloxane bridge. The compound has the general formula:

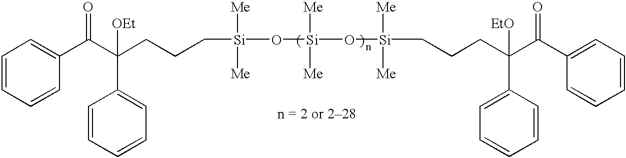

Synthesis of these compounds is described in U.S. Pat. No. 4,477,326, the teachings of which are incorporated by reference for United States practice.

The relative amounts of UV absorber and initiator will vary depending upon the desire degree of absorbance for the specific application. Generally the ratio of photoinitiator to UV absorber will range from about 1:1 to about 25:1, with 6:1 to 25:1 preferred. Generally, the relative amounts of photoinitiator and UV absorber can be calculated using the formula:

cos T=A=ε₁b₁c₁+ε₂b₂c₂

wherein T is transmittance, A is absorbance, ε₁ is the extinction coefficient for the UV absorber, b₁ is the path length of the light and c₁ is the concentration of the UV absorber. ε₂, b₂, and c₂ are as defined above except that they relate to the photoinitiator. In practice, it has been found that the actual absorbance is generally less than the predicted values such that the amount use should generally be at least 1.5 times the calculated amount.

The amounts of absorber and initiator can also be expressed in terms of the percent of the final composition. Using this reference, the amount of absorber present may range from 0.0625 weight percent to 2 weight percent with 0.25 to 1.0 weight percent preferred. The amount initiator present may range from 0.05 to 0.25 weight percent. It will be understood by tbose skilled in the art that the actual amounts of each absorber and initiator used are dependent upon the nature of the initiator and absorber.

The photoinitiator and UV absorber are combined with the polymers, monomers or macromers to be polymerized or crosslinked. In one embodiment, the photoinitiator is bound to the macromers. In other embodiments, the photoinitiator remains free in the mixture.

Monomers and macromers useful in the practice of the invention contain photopolymerizable functional groups. Typical photopolymerizable functional groups contain a group consisting of acrylate, allyloxy, cinnamoyl, methacrylate stibenyl and vinyl, with acrylate and methacrylate preferred.

The preferred macromers used in the practice of the invention are: polysiloxanes or polyacrylate macromers endcapped with photopolymerizable groups.

Because of the preference for flexible and foldable IOLs, an especially preferred class of MC monomers is polysiloxanes endcapped with a terminal siloxane moiety that includes a photopolymerizable group. An illustrative representation of such a monomer is:

X—Y—X¹

wherein Y is a siloxane which may be a monomer, a homopolymer or a copolymer formed from any number of siloxane units, and X and X¹ may be the same or different and are each independently a terminal siloxane moiety that includes a photopolymerizable group. Illustrative examples of Y include:

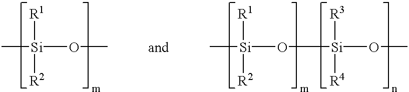

wherein:

m and n are independently each an integer and

R¹, R², R³, and R⁴, are independently each hydrogen, alkyl (primary, secondary, tertiary, cyclo), aryl, or heteroaryl. In preferred embodiments, R¹, R², R³, and R⁴, is a C₁-C₁₀ alkyl or phenyl. Because MC monomers with a relatively high aryl content have been found to produce larger changes in the refractive index of the inventive lens, it is generally preferred that at least one of R¹, R², R³, and R⁴ is an aryl, particularly phenyl. In more preferred embodiments. R¹, R², R³ are the same and are methyl, ethyl or propyl and R⁴ is phenyl.

Illustrative examples of X and X¹ (or X¹ and X depending on how the MC polymer is depicted) are:

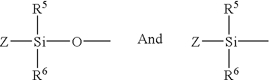

respectively wherein:

R⁵ and R⁶ are independently each hydrogen, alkyl, aryl, or heteroaryl; and

Z is a photopolymerizable group.

In preferred embodiments R¹ and R⁶ are independently each a C₁ and C₁₀ alkyl or phenyl and Z is a photopolymerizable group that includes a moiety selected from the group consisting of acrylate, allyloxy, cinnamoyl, methacrylate, stibenyl, and vinyl. In more preferred embodiments, R⁵ and R⁶ is methyl, ethyl, or propyl and Z is a photopolymerizable group that includes an acrylate or methacrylate moiety.

In especially preferred embodiments, an MC monomer is of the following formula:

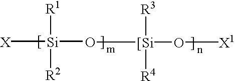

wherein X and X¹ are the same and R¹, R², R³, and R⁴ are as defined previously, and m and n as integers. Illustrative examples of such MC monomers include dimethylsiloxane-diphenylsiloxane copolymer endcapped with a vinyl dimethylsilane group; dimethylsiloxane-methylphenylsiloxane copolymer endcapped with a methacryloxypropyl dimethylsilane group; and dimethylsiloxane endcapped with a methacryloxypropyldimethylsilane group. Although any suitable method may be used, a ring-opening reaction of one of more cyclic siloxanes in the presence of triflic acid has been found to be a particularly efficient method of making one class of inventive MC monomers. Briefly, the method comprises contacting a cyclic siloxane with a compound of the formula:

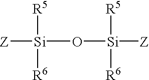

in the presence of triflic acid wherein R⁵, R⁶, and Z are as defined previously. The cyclic siloxane may be a cyclic siloxane monomer, homopolymer, or copolymer. Alternatively, more than one cyclic siloxane may be used. For example, a cyclic dimethylsiloxane tetramer and a cyclic methyl-phenylsiloxane trimer are contacted with bismethacryloxypropyltetramethyldisiloxane in the presence of triflic acid to form a dimethyl-siloxane methyl-phenylsiloxane copolymer that is endcapped with a methacryloxylpropyl-dimethylsilane group, an especially preferred MC monomer.

The macromers useful in practice of the invention generally have a molecular weight (Mn) of from 700 to 30,000 with between 700 to 1000 preferred.

In one embodiment, the UV absorber, photoinitiator and a photopolymerizable modifying composition are dispersed within an optical element. When the element is exposed to a UV light source of sufficient intensity, the UV light exceeds the absorbence capacity of the UV absorber and stimulates the photoinitiator. The photoinitiator, in turn, induces polymerization of the modifying composition. The polymerization of the modifying composition causes changes in the optical properties of the element. When the UV source is removed or when the intensity falls below the absorbence capacity of the UV absorber, the polymerization reactor ceases, preventing further changes to the optical properties.

In the preferred embodiment, an intraocular lens (“IOL”) is prepared from a first polymer matrix having a modifying composition dispersed therein. The modifying composition is capable of photoinduced polymerization. The IOL also contains a mixture of UV absorber and UV initiator as described above. The IOL is then implanted into a patient. After wound healing is complete, the optical quality of the lens is then adjusted by exposing at least a portion of the lens to ultraviolet light for a sufficient time and intensity to cause the UV initiator to induce polymerization of the modifying composition. The photopolymerization of the modifying composition, in turn, causes changes in the optical properties of the IOL.

While the UV absorber/initiator blends of the invention are particularly useful in light of adjustable optical elements, they can be used in any composition where it is desirable to delay a photoinitiated reaction until a prescribed level of intensity or wavelength has been met.

One example of this is UV curable compositions. Generally, care must be taken not to expose these compositions to ambient light because even at the low intensity of cure light (about 6.0 milliwatts) the photoinitiated curing reaction takes place. By adding sufficient UV absorber, the reaction can be delayed until the UV light intensity exceeds 6.0 milliwatts. This allows the curable composition to be more easily used under ambient conditions, yet cured at intensities well below the maximum safe exposure levels.

### EXAMPLES

The following examples are offered by way of example and are not intended to limit the scope of the invention in any manner.

A series of siloxane slabs were prepared as reflected in the tables below. In the control experiments, Part A consisted of a silicone polymer Silicone MED 6820. Part B was prepared by mixing Silicone 6820 with a catalyst Pt-divinyltetramethyldisiloxane complex. Parts A and B were separately degassed to remove any air and then blended together. The mixture was then degassed and placed into a 1 mm thick mold where it was held in a Carver press for 24 to 48 hours at pressures up to about 1000 psi and at a temperature of about 37° C.

The experimental sections were prepared in the same manner except that a blend of modifying composition, UV absorber and UV initiator was first prepared and then added to Part A. The proportions of the components were as listed in Table I. The modifying composition (identified as CalAdd in Table I) was methacrylate endcapped dimethylsiloxane diphenylsiloxane copolymer with a Mn of from 700 to 1000 g 1 mole.

In the table below, the initiators used consisted generally of the following compounds, Irgacure 651, a commercially available UV initiator made by Ciba Specialty Chemicals, Inc.; Initiator B-pdms-B which is a blend of dual benzoin structures having the general structure:

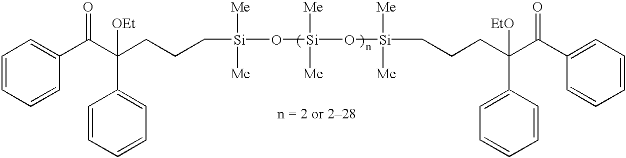

wherein n ranges from 2 to 28, and B-L4-B which has the same general structure as above except with n=2 only. Use of these initiators are preferred for applications where clarity is essential such as optical elements. In other applications where clarity is not essential, the use of other initiators such as Irgacure 369 is acceptable. Again, the key is to use an initiator that is triggered in the desire range of wavelengths and does not require an intensity in excess of prescribed safety standards.

In the experiments recited in the table below, the ultraviolet absorbing compound used is UVAM a commercially available absorber. While the use of UVAM is preferred, other ultraviolet absorbing compounds may be used.

In the experiments reported in Table I, polymer slabs were prepared as described above. Sections of the slab were then taken and exposed to light at 365 nm for 30 to 120 minutes at intensities ranging from 0.01 to 8 milliwatts per square centimeters. The transmission and absorbance of the UV light through the section was determined by Differential Photocalorimetric Analyzer and reported in the table as 10% Transmittance and Δ H (heat of polymerization).

TABLE 1

| | Part A | Part B | Irg 651 | B-L4-B | B-pdms-B | UVAM | Cal.Add | Intensity | | ΔH | 10% | |
|---|---|---|---|---|---|---|---|---|---|---|---|---|
| Experiment | Wt % | Wt % | Wt % | Wt % | Wt % | Wt % | Wt % | mW/cm² | Environ | J/g | T | |
| Control | 34.9 | 34.9 | 0.23 | | | | 29.97 | 4.82 | N₂ | −20.584 | 290 | nm |
| | | | | | | | | 3.11 | Air | −18.586 | | |
| 1 | 34.9 | 34.9 | 0.23 | | | 0.04 | 29.93 | 4.82 | N2 | −25.832 | 384 | nm |
| | | | | | | | | 3.11 | Air | −11.575 | | |
| 2 | 46.7 | 33.3 | 0.23 | | | 0.02 | 19.75 | 9.61 | N2 | −6.397 | 363 | nm |
| | | | | | | | | 9.7 | Air | −8.742 | | |
| 3 | 46.70 | 33.3 | 0.23 | | | 0.02 | 19.75 | 9.61 | N2 | −2.839 | 361 | nm |
| | | | | | | | | 9.61 | Air | −8.156 | | |
| 4 | 36.3 | 33.3 | 0.46 | | | 0.02 | 29.92 | 6.7 | N2 | 15.631 | 364 | nm |
| | ″ | ″ | ″ | | | ″ | ″ | 6.59 | Air | −21.363 | | |
| | ″ | ″ | ″ | | | ″ | ″ | 8.66 | Aqueous | −25.473 | | |
| | ″ | ″ | ″ | | | ″ | ″ | 6.77 | ″ | −27.273 | | |
| | ″ | ″ | ″ | | | ″ | ″ | 6.37 | ″ | −19.545 | | |
| | ″ | ″ | ″ | | | ″ | ″ | 4.33 | ″ | −23.183 | | |
| | ″ | ″ | ″ | | | ″ | ″ | 087 | ″ | −17.785 | | |
| 5 | 36.3 | 33.2 | ″ | | 0.5 | 0.02 | 29.98 | 6.68 | N2 | −18.36 | 323 | nm |
| | ″ | ″ | ″ | | | ″ | ″ | 6.68 | Air | −13.025 | | |
| 6 | 36.2 | 33.1 | | | 0.75 | 0.03 | 29.82 | 7.49 | N2 | −20.231 | 364 | nm |
| | ″ | ″ | | | ″ | ″ | ″ | 3.74 | ″ | −17.483 | | |
| | ″ | ″ | | | ″ | ″ | ″ | 7.49 | Air | −16.890 | | |
| | ″ | ″ | | | ″ | ″ | ″ | 3.74 | ″ | −2.654 | | |
| | ″ | ″ | | | ″ | ″ | ″ | 7.96 | Aqueous | −19.147 | | |
| | ″ | ″ | | | ″ | ″ | ″ | 5.92 | ″ | −21.672 | | |
| | ″ | ″ | | | ″ | ″ | ″ | 3.98 | ″ | −20.231 | | |
| | ″ | ″ | | | ″ | ″ | ″ | 0.796 | ″ | −21.880 | | |
| 7 | 35.2 | 33.1 | | | .75 | .04 | 29.78 | 7.86 | Air | −10.275 | 383 | nm |
| 8 | 36.1 | 33.1 | | | 1.0 | 0.04 | 29.76 | 7.86 | Air | −13.931 | 383 | nm |
| | ″ | ″ | | | ″ | ″ | ″ | 8.05 | Aqueous | −22,899 | | |
| | ″ | ″ | | | ″ | ″ | ″ | 6.26 | ″ | −18.322 | | |
| | ″ | ″ | | | ″ | ″ | ″ | 5.92 | ″ | −29.994 | | |
| | ″ | ″ | | | ″ | ″ | ″ | 4.03 | ″ | −18710 | | |
| | ″ | ″ | | | ″ | ″ | ″ | 0.85 | ″ | −11.459 | | |
| 9 | 36 | 32.9 | | 1.0 | | 0.04 | 30.096 | 6.89 | Air | −10.015 | 387 | nm |
| | ″ | ″ | | ″ | | | | 3.56 | ″ | −7.835 | | |
| | ″ | ″ | | ″ | | | | 3.45 | ″ | −6.062 | | |
| | ″ | ″ | | ″ | | | | 2.07 | ″ | −3.062 | | |
| | ″ | ″ | | ″ | | | | 7.36 | Aqueous | −20.009 | | |
| | ″ | ″ | | ″ | | | | 4.81 | ″ | −18.071 | | |
| | ″ | ″ | | ″ | | | | 2.4 | ″ | −15.171 | | |
| | ″ | ″ | | ″ | | | | 0.74 | ″ | −11.869 | | |
| | ″ | ″ | | ″ | | | | 0.01 | ″ | −9.219 | | |
| 10 | 36 | 32.9 | | | 1.0 | 0.04 | 30.096 | 6.98 | Air | −11.366 | 383 | |
| | ″ | ″ | | | ″ | ″ | ″ | 4.01 | ″ | −9.002 | | |
| | ″ | ″ | | | ″ | ″ | ″ | 2.13 | ″ | −6.163 | | |
| | ″ | ″ | | | ″ | ″ | ″ | 0.71 | ″ | −1.45 | | |
| | ″ | ″ | | | ″ | ″ | ″ | 7.36 | Aqueous | −14.484 | | |
| | ″ | ″ | | | ″ | ″ | ″ | 4.6 | ″ | −15.295 | | |
| | ″ | ″ | | | ″ | ″ | ″ | 2.59 | ″ | −16.449 | | |
| | ″ | ″ | | | ″ | ″ | ″ | 0.74 | ″ | −13.819 | | |
| | ″ | ″ | | | ″ | ″ | ″ | 0.097 | ″ | −13.819 | | |

A second series of siloxane slabss were prepared as reflected in the tables below. The slabs were prepared as sdescribed above except that two UV absorbers were used in the formula terms noted in Table 2. The absorber were UVAM (2-5 Chloro-2-H-benzotrazole-z-yl)-6-(1,1-dimethyl)-4-ethylphenoli and dihydroxy benzophenine. The photoiniator used was BL4B described above. The slabs were valuated in the manner described above with the results reported in Table 2.

TABLE 2

| | | | | Photo- | | |
|---|---|---|---|---|---|---|
| | Macromer | UVAM | D4BP | iniator | | T25% |
| Example # | Wt % | Wt % | Wt % | Wt % | DHJ/g | Min |
| 11 | 29.675 | .025 | 0.025 | .25 | −28.586 | 6.7 |
| 12 | 29.015 | .0375 | 0.0375 | .25 | −28.354 | 8.03 |
| 13 | 29.65 | .05 | 0.05 | .75 | −30.882 | 21.67 |
| 14 | 34.65 | 0.025 | 0.025 | .3 | −55.461 | 4.89 |
| 15 | 34.625 | 0.0375 | 0.0375 | .3 | −29.617 | 11.27 |
| 16 | 34.6 | 0.05 | 0.05 | .3 | −38.069 | 7.13 |
| 17 | 34.6 | .05 | .05 | .3 | −38.879 | 12.72 |

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same the corresponding embodiments described herein may be utilized according to the present invention. Accordingly, the appended claims are intended to include within their scope such processes, machines, manufacture, compositions of matter, means, methods, or steps.

What is claimed is:

1. A blend of photoabsorber and photoinitiator wherein said photoabsorber is present in an amount that prevents the photoinitiator from activating until a specified light intensity is achieved.

2. The blend of claim 1 wherein such photoabsorber is an ultraviolet light absorber and said photoinitiator is a UV initiator

3. The blend of claim 1 wherein said photoabsorber absorbs light in the range of 300-390 nm.

4. The blend of claim 1 wherein said photoinitiator is stimulated by light in the range of 320 to 380 mn.

5. The blend of claim 1 wherein said photoabsorber contains at least one moiety having the general structure 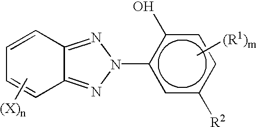
wherein each x is independently selected from the group consisting of H, halogen, alkyl, hydroxyl, amino, carboxyl, alkoxy and substituted alkoxy, R¹ is independently selected from the group consisting of H, alkyls, substituted alkyls, alkoxy, substituted alkoxy, hydroxyl, amino and carboxyl; R² contains a vinyl moiety, m is an integer from 1-3 and n is an integer from 1-4.

6. The blend of claim 1 wherein said photoinitiator contains at least one moiety having the general structure: 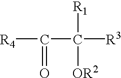
wherein R³ and R⁴ are independently selected from the group consisting of H, alkyl, aryl, substituted alkyl and substituted aryl, and R⁵ and R⁶ are independently selected from the group consisting of phenyl and substituted phenyl.

7. The blend of claim 1 wherein the photoabsorber contains a moiety having the general structure: 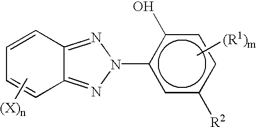
wherein each x is independently selected from the group consisting of H, halogen, alkyl, hydroxyl, amino, carboxyl; each R¹ is independently selected from the group consisting of H, alkyl, substituted alkyl, alkoxy, substituted alkoxy, hydroxyl, amino and carboxyl; R² contains a vinyl moiety; m is an integer from 1-3; and n is an integer from 1-4; and
the photoinitiator contains a moiety having the general structure: 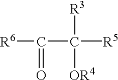
wherein R³ and R⁴ are independently selected from the group consisting of H, alkyl, substituted alkyl, aryl and substituted aryl; and R³ and R⁴ are independently selected from the group consisting of phenyl and substituted phenyl.

8. The blend of claim 1 wherein the ratio of photoinitiator to photoabsorber ranges from 1:1 to 25:1.

9. The blend of claim 1 wherein said photoabsorber has the structure: 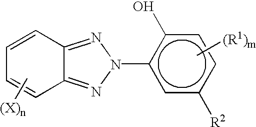
wherein x is chlorine and R¹ is tertiary butyl and R² contains a vinyl moiety.

10. A blend of ultraviolet absorbers and ultraviolet initiators wherein said ultraviolet absorber contains a moiety having the general structure: 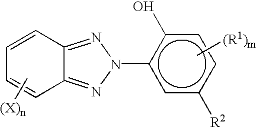
wherein each x is independently selected from the group consisting of H, halogen, alkyl, hydroxyl, amino, carboxyl, alkoxy and substituted alkoxy; each R¹ is independently selected from the group consisting of H, alkyl, substituted alkyl, alkoxy, substituted alkoxy, hydroxyl, amino and carboxyl; R² contains a vinyl moiety; m is an integer from 1-3; and n is an integer from 1-4; and the photoinitiator contains at least one moiety having the structure: 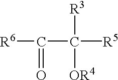
wherein R³ and R⁴ are independently selected from the group consisting of H, alkyl, substituted alkyl, aryl, and substituted aryl; and R³ and R⁴ are independently selected from the group consisting of phenyl and substituted phenyl, the ratio of photoinitiator to photoabsorber ranges from 1:1 to 25:1.

11. The blend of claim 1 wherein said photoinitiator has the structure: 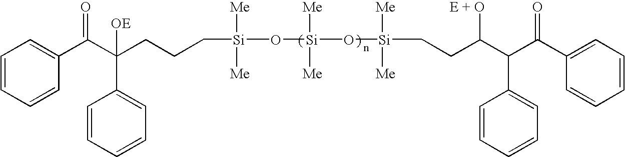
wherein n ranges from 2-28.

12. The blend of claim 11 wherein n=2.
